(19) United States
(12) Patent Application Publication
(10) Pub. No.: US 2004/0205183 A1
(43) Pub. Date: Oct. 14, 2004

(54) Method and system for avoiding tracking communication connection state until accepted

(75) Inventor: Don Bowman, Waterloo (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Sandvine Incorporated, Waterloo, ON (CA)

(21) Appl. No.: 10/383,619

(22) Filed: Mar. 10, 2003

(51) Int. Cl. G06F 15/173

(52) U.S. Cl. 709/224; 709/227

(57) ABSTRACT

The invention relates to a system and method for reducing and reconstructing state entries for initiator messages in a communication network. It compares a set of common options to each initiator message. If the message has the common options, no state entry is created for the message. This saves resources in systems such as Peer to Peer networks utilizing TCP/IP, where there is often no acceptor (SYN/ACK) to an initiator (SYN). By utilizing the present invention an agent dealing with communications need not maintain state for every connection. Upon receiving an acceptor message corresponding to an initiator message, the agent may create a state entry from the common options.

### BACKGROUND OF THE INVENTION

Most communication networks have an initiator and an acceptor. For example, in a telephone network, an initiator dials a telephone number. An acceptor recognizes the ring of the telephone and picks it up to reply. Many telephone calls are not answered. This occurs when the initiator causes the phone to ring, but the acceptor is not available to reply. For a communications agent that tracks telephone calls, such as a wire-tapping device, it would be advantageous for the agent to ignore an outgoing call unless the call is accepted. Advantageous, in that the communications agent need not waste resources in maintaining information on each outgoing call.

Similarly, in the case of computer network communications, for example a TCP/IP communication session, it would be desirable to ignore an initiator message unless an acceptor replies.

The need for a communications agent to ignore outgoing calls and only be concerned with calls that are accepted, provides for a more efficient use of communication resources. The present invention addresses this need.

### SUMMARY OF THE INVENTION

The present invention relates to a system and method for reducing and reconstructing state entries for initiator messages in a communication network.

One aspect of the present invention is a method for avoiding the creation of a state entry for an uncompleted communication connection, said method comprising the steps of:

a) comparing initiator message options to a set of common options;

b) if the result of step a) is a match, ignoring said initiator message; and

c) if the result in step a) does not result in a match, creating a state entry for said initiator message.

In another aspect of the present invention there is provided a system for avoiding the creation of a state entry for an undesired communications connection, said system comprising:

a) means for comparing initiator message options to a set of common options;

b) means for ignoring said initiator message if said means for comparing finds a match; and

c) means for creating a state entry for said initiator message if said means for comparing do not find a match.

In yet another aspect of the present invention there is provided a computer readable medium containing instructions for avoiding the creation of a state entry for an undesired communications connection, said medium comprising:

a) instructions for comparing initiator message options to a set of common options;

b) instructions for ignoring said initiator message if said instructions for comparing find a match; and

c) instructions for creating a state entry for said initiator message if said instructions for comparing do not find a match.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram of networks connected to an agent;

FIG. 2 is a flowchart of the processing for an initiator message; and

FIG. 3 is a flowchart of the processing for an acceptor message.

### DETAILED DESCRIPTION OF THE INVENTION

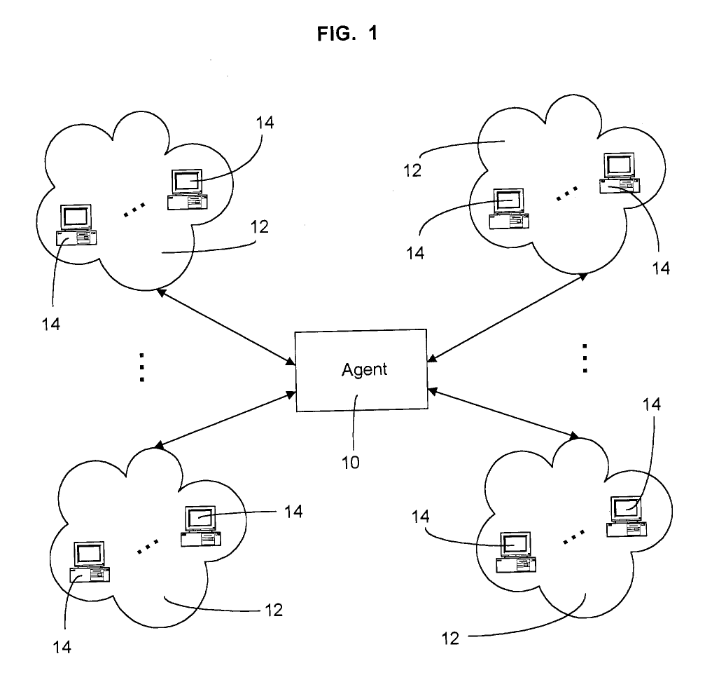

FIG. 1 is a block diagram of networks connected to an agent. The present invention resides in agent 10. Agent 10 monitors all traffic between a plurality of networks 12. Examples of networks 12 include but are not limited to, an Internet network utilizing TCP/IP, a corporate network utilizing Ethernet, or a network utilizing telephone communications. Each network 12 is operatively connected to agent 10 to permit bi-directional communication with agent 10. Each network 12 comprises a plurality of nodes 14. Each node 14 is an electronic device capable of transmitting data and receiving data within network 12. Examples of such devices include, but are not limited to: desktop computers, laptop computers, personal digital assistants and telephones.

By way of example, we refer to networks 12 that are peer to peer networks. It is not the intent of the inventor to restrict the present invention to peer to peer communications, but rather to provide an example for implementation.

In the case of peer to peer communications, an initiator (i.e. a node 14) attempts to locate other nodes 14 that are active and running the same file-sharing protocol. Such communications may utilize Transmission Control Protocol/Internet Protocol (TCP/IP). In such a case the initiator uses the TCP/IP Synchronise (SYN) packet and the acceptor responds with a Synchronise Acknowledge (SYN/ACK) packet. Agent 10 would hear both parts of this conversation, and wishing to do something with it, could spend a large amount of resources, such as processing and memory, to create state entries to track the initial SYN without ever hearing the SYN/ACK. Thus a method of reconstructing the information of the initiator, only on the acceptance, would be beneficial.

The examples provided are for TCP/IP, and specifically for peer-to-peer communications over TCP/IP, but can apply more generally to any application run over any communications medium such as ATM or wireless.

The problem with simply ignoring the initial connection attempt (SYN packet) is that it contains flags and options that will not be repeated. For example: window scaling option, maximum segment size, and selective acknowledgement. The communication flow cannot be properly reconstructed without these flags and options. The present invention attempts to ignore SYN packets without creating a state entry to remember it. This can be achieved by utilizing the property that the majority of SYN packets contain the same flags and options. If a SYN packet is detected with a known common set of options, it is ignored. Subsequently if a SYN/ACK is received for which no state entry exists, a state entry is created using the value of the common options.

The most common set of options may either be empirically determined or set by the user, or an implementation of the invention may dynamically learn them as it operates.

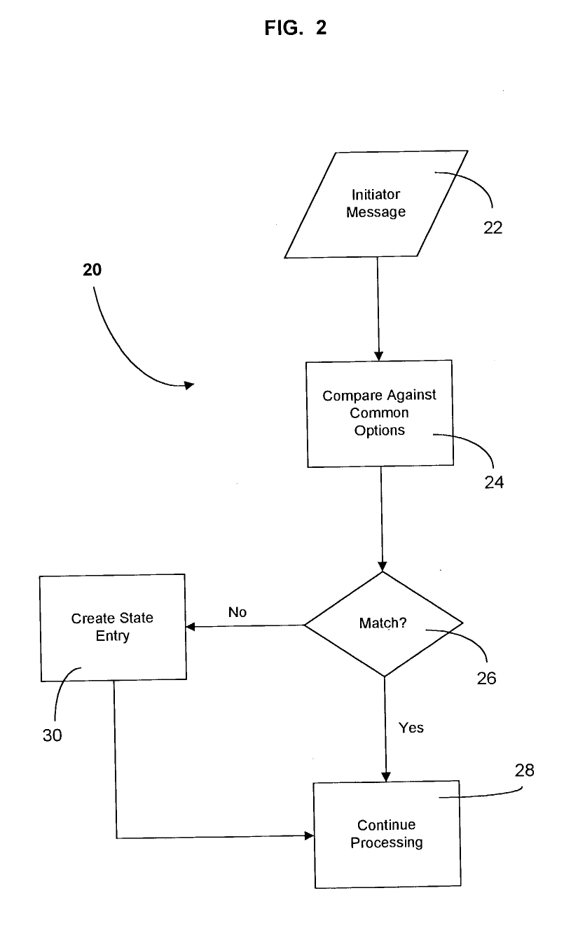

Referring now to FIG. 2, a flowchart of the processing for an initiator message is shown generally as 20. Beginning at step 22, an initiator message is detected by agent 10. At step 24 the options of an initiator message are compared to a set of common options.

If it is determined at step 26 that the options of an initiator message match the set of common options, processing moves to step 28 where the message is ignored and processing continues by continuing to look for the next initiator message. If the message does not match the set of common options a state entry of the message is created at step 30 and processing moves to step 28. In the case of the message being a TCP/IP SYN packet, then a state entry would typically consist of the initiator message options, the source IP address, the destination IP address, the TCP port number of the source, and the TCP port number of the destination.

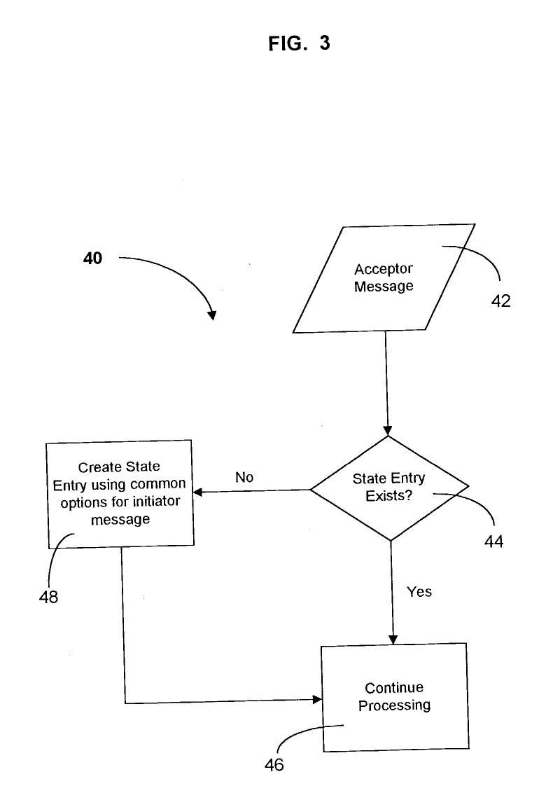

Referring next to FIG. 3, a flowchart of the processing for an acceptor message is shown generally as 40. Beginning at step 42 an acceptor message is detected by agent 10. At step 44 a test is made for the existence of a state entry for a matching initiator message. State entries may be stored in any number of data structures, such as a hash table or a list. If a match is found, processing moves to step 46 where the existing state entry of the initiator message is utilized and processing continues to look for further acceptor messages. If at step 44 no match is found, processing moves to step 48. At step 48, a state entry is created using the common options of initiator messages.

As described above the present invention minimizes the use of computing resources in a communications network by not storing the state of a common initiator. Should an acceptor respond to a message from a common initiator the state may be easily and quickly reconstructed.

It is not the intent of the inventor to restrict the present invention to the use of a TCP/IP network, it is provided only as an example of a communication network. Any communication network requiring the maintenance of a communication state may make use of the present invention.

It is the intent of the inventor that the implementer of the present invention may select any set of options to determine a common set of options in an initiator message, dependent upon the communication protocol used by the initiator message.

Further the present invention is useful in minimizing the damage of attacks that send only initiator messages in an attempt to disable the agent. In the case of TCP/IP, the present invention would enable the agent to resist an attack of multiple SYN messages.

Although the present invention has been described as being a software based invention, it is the intent of the inventor to include computer readable forms of the invention. Computer readable forms meaning any stored format that may be read by a computing device.

Although the invention has been described with reference to certain specific embodiments, various modifications thereof will be apparent to those skilled in the art without departing from the spirit and scope of the invention as outlined in the claims appended hereto.

I claim:

1. A method for avoiding the creation of a state entry for an uncompleted communication connection, said method comprising the steps of:
a) comparing initiator message options to a set of common options;
b) if the result of step a) is a match, ignoring said initiator message; and
c) if the result in step a) does not result in a match, creating a state entry for said initiator message.

2. The method of claim 1 wherein if at step c) it is determined that the initiator message is a TCP/IP SYN message, creating a state entry comprising: said initiator message options, IP source and destination addresses and TCP source and destination ports.

3. The method of claim 1 further comprising the steps of:
d) determining if a state entry for an acceptor message exists;
e) if the result of step d) locates a match, utilizing an existing state entry; and
f) if the result of step d) does not locate a match, creating a state entry using said set of common options.

4. The method of claim 3 wherein if at step f) it is determined that said acceptor message is a TCP/IP SYN/ACK message, creating a state entry comprising said set of common options, IP source and destination addresses and TCP source and destination ports.

5. A system for avoiding the creation of a state entry for an undesired communications connection, said system comprising:
a) means for comparing initiator message options to a set of common options;
b) means for ignoring said initiator message if said means for comparing finds a match; and
c) means for creating a state entry for said initiator message if said means for comparing do not find a match.

6. The system of claim 5 wherein if said means for creating determines that an initiator message is a TCP/IP SYN message, creating a state entry comprising: said initiator message options, IP source and destination addresses and TCP source and destination ports.

7. The system of claim 5 further comprising:
d) means for determining an existing state entry for an acceptor message;
e) means for utilizing said existing state entry; and
f) means for creating a new state entry, using a set of common options, should said means for determining not locate an existing state entry.

8. The system of claim 7 wherein if said means for creating determines that said acceptor message is a TCP/IP SYN/ACK message, utilizing means for creating a state entry comprising said set of common options, IP source and destination addresses and TCP source and destination ports.

9. A computer readable medium containing instructions for avoiding the creation of a state entry for an undesired communications connection, said medium comprising:
a) instructions for comparing initiator message options to a set of common options;
b) instructions for ignoring said initiator message if said instructions for comparing find a match; and
c) instructions for creating a state entry for said initiator message if said instructions for comparing do not find a match.

10. The medium of claim 9 wherein if said instructions for creating determine that an initiator message is a TCP/IP SYN message, creating a state entry comprising: said initiator message options, IP source and destination addresses and TCP source and destination ports.

11. The medium of claim 9 further comprising:
d) instructions for determining if an existing state entry for an acceptor message exists;
e) instructions for utilizing said existing state entry; and
f) instructions for creating a new state entry, using a set of common options, if said instructions for determining do not locate an existing state entry.

12. The method of claim 11 wherein if said instructions for creating determine that said acceptor message is a TCP/IP SYN/ACK message, creating a state entry comprising: said set of common options, IP source and destination addresses and TCP source and destination ports.
